(19) United States
(12) Patent Application Publication
(10) Pub. No.: US 2012/0143666 A1
(43) Pub. Date: Jun. 7, 2012

(54) SYSTEMS AND METHODS FOR PROCESSING COUPONS

(75) Inventors: Ramon Anton Carrion, Princeton, NJ (US); Glenn Chin, Short Hills, NJ (US)

(73) Assignee: BED, BATH & BEYOND INC.

(21) Appl. No.: 13/295,474

(22) Filed: Nov. 14, 2011

Related U.S. Application Data
(60) Provisional application No. 61/413,651, filed on Nov. 15, 2010.

(51) Int. Cl. G06Q 30/02

(52) U.S. Cl. 705/14.22; 705/14.26; 705/14.23

(57) ABSTRACT

Systems and methods for tracking and managing the distribution, activation, and redemption of online coupons are provided. In one aspect, the online coupon may be transmitted to one or more users as an electronic mail (“email”) coupon. A user may then act upon the online coupon to view, activate and redeem the incentive offered by the coupon. A user's actions in response to the online coupon, such as the viewing actions, activation actions, and redemption actions, may be tracked and managed to reduce the possibility of fraud or misuse, and to identify the efficacy of the incentives offered by the coupon.

### CROSS-REFERENCE TO RELATED APPLICATIONS

The present application claims the benefit of the filing date of U.S. Provisional Application No. 61/413,651, filed on Nov. 15, 2010 and entitled “SYSTEMS AND METHODS FOR TRACKING THE DISTRIBUTION, ACTIVATION AND REDEMPTION OF ON-LINE COUPONS” the disclosure of which is hereby incorporated herein in its entirety by reference.

### FIELD OF INVENTION

The present invention generally relates to managing the distribution, activation and redemption of online coupons. More particularly, it relates to managing the distribution, activation, and redemption of electronic-mail coupons (“email coupons”) that are sent to selected consumers of a retail organization, and which may be applied towards the online purchase of one or more goods and services offered at a retailer's web-site.

### BACKGROUND OF THE INVENTION

The advent of the Internet has provided new means for retailers to entice and provide value to a large number of potential consumers. For example, many retailers use email to communicate discount offers to consumers. Such discount offers are typically in the form of an online coupon, which may be applied towards the purchase of various products or services offered by the retailer. As many retailers provide an Internet website where its products may be purchased electronically, email coupons can be efficiently redeemed by a consumer without having to physically print the coupon, such as by entering an electronic code associated with the email coupon, or by associating the coupon with other consumer related information maintained at a retailer's website.

While the distribution of online coupons is a relatively cost effective way for a retailer to target potential consumers compared to the conventional postal mailing of printed paper coupons, there are several factors that can increase the cost to a retailer, such as greater difficulty in tracking, coupon effectiveness, and fraud prevention.

### SUMMARY OF THE INVENTION

Aspects of the invention are employed for efficiently managing the distribution, activation, and redemption of electronic coupons by a retailer to one or more selected consumers.

In one aspect, a method for offering incentives via an electronic network is provided. The method includes receiving, over the electronic network, confirmation from a user indicating the user's acceptance of an incentive transmitted to the user over the electronic network, the incentive including a discount associated with one or more products or services offered by a retailer; receiving, over the electronic network, a request from the user to purchase at least one of the one or more products or services associated with the discount; and, providing, over the electronic network, the user with an option of 1) applying the incentive towards the purchase of the at least one product or service selected by the user or 2) saving the incentive for another purchase.

In another aspect, a method for activation and redemption of online coupons is provided. The method includes receiving an indication that an online coupon transmitted to a user over a network has been viewed by the user; activating, with a processor, the online coupon in response to receiving an activation request over the network, the online coupon being activated in association with an electronic address of the user; and, receiving, over the network, a request for purchase of one or more items selected by the user, and, in response to the request, providing an option, but not a requirement, to the user to redeem the activated online coupon towards the purchase of one or more eligible items in the one or more items selected for purchase by the user.

In a yet another aspect, a computer-readable medium having encoded instructions executable by a processor for processing coupons is provided. The instructions, when executed by the processor, configure the processor to receive confirmation from a user indicating the user's acceptance of a coupon transmitted to an electronic address of the user, where the coupon includes a discount associated with one or more items sold by a retailer; activate the coupon in association with the electronic address of the user in response to receiving the confirmation, and notify the user at the electronic address that the coupon has been activated. The instructions further configure the processor to receive a request from the user to purchase a selected one of the one or more items sold by the retailer in association with the electronic address of the user; and, provide the user with a first option to purchase the selected item using a payment method selected by the user and a second option to apply the coupon towards the purchase of the selected item.

### DESCRIPTION OF THE DRAWINGS

FIG. 1 illustrates a process flow of a system in accordance with various aspects of the invention.

FIG. 2 illustrates an exemplary screen shot of an email coupon provided to a consumer or user of the system.

FIG. 3 illustrates an exemplary screen shot of a web page notifying a consumer or user that a coupon has been activated.

FIG. 4 illustrates an exemplary screen shot of a web page indicating that the coupon is already active.

FIGS. 5A-5C illustrate various messages indicating the status of a coupon.

FIG. 6 illustrates an exemplary screen shot of a web page for redemption of an activated coupon towards the purchase of one or more items offered by a retailer.

FIG. 7 illustrates an exemplary screen shot of a confirmatory web page displayed to the consumer or user.

FIG. 8 illustrates an exemplary screen shot of a shipping incentive displayed to the consumer or user.

FIG. 9 illustrates exemplary consumer information data maintained by the retailer in accordance with one aspect of the invention.

FIG. 10 illustrates an apparatus for implementing various components of the system disclosed in FIG. 1.

FIG. 11 illustrates a process in accordance with various aspects of the invention.

### DETAILED DESCRIPTION

Aspects, features and advantages of the invention will be appreciated when considered with reference to the following description of preferred embodiments and accompanying figures. The same reference numbers in different drawings may identify the same or similar elements. Furthermore, the following description is not limiting; the scope of the invention is defined by the appended claims and equivalents.

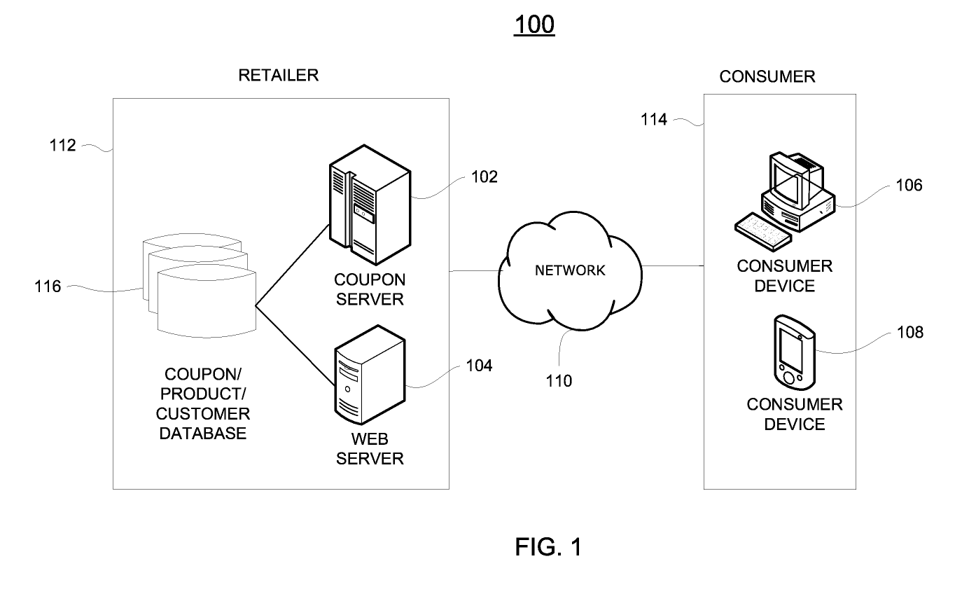

FIG. 1 illustrates a topology of a system 100 in accordance with various aspects of the invention disclosed herein. As shown, system 100 may include a coupon server device 102, a web server device 104, and consumer devices 106, 108 communicatively coupled to each other via network 110. Network 110 may comprise the Internet, intranet, or any known type of wired or wireless local-area or wide-area network. Functionally, the network 110 allows communication between consumer devices 106, 108, and the server devices 102, 104. The coupon server 102 and the web server 104 may be implemented via one or more general purpose computers or dedicated computing server devices executing one or more applications or programs adapted to provide functionality for managing the distribution, activation, and redemption of online coupons by retailer 112 to one or more selected consumers 114 as described below. In addition, the consumer devices 106, 108 may also be general or dedicated computing devices, such as a personal computer, a laptop, a cell phone, or a Personal Digital Assistant (“PDA”). In general, consumer devices 106,108 may comprise any device with sufficient computing resources that may be used by consumers 114 to retrieve, view, activate, and redeem online coupons offered by the retailer 112. In addition to the foregoing, the system 100 may also include one or more computer readable mediums or databases 116, which may be provided by the retailer 112 for maintaining information, such as, for example, coupon information, consumer information, and product information as described in detail below.

In one aspect, the database 116 may include coupon information. Coupon information may include, for example, the discounts or incentives created by the retailer 112, the terms and conditions associated with the coupons, the expiration date of the coupons, and any other useful information governing the use of the coupons and the retailer's marketing activities.

Database 116 may also include consumer or user information. Consumer information may include, for example, information regarding one or more consumers, such as a consumer name, electronic address (e.g., email address), home and/or office address, telephone number(s), consumer preferences, and any other useful consumer related information available to the retailer. In one aspect, the consumer information may also include information related to the consumers' interaction with the retailer, such as, for example, a listing of current or past items ordered or purchased by the consumers from the retailer's website, the shipping, delivery and billing information associated with one or more orders of the consumers, etc.

In addition, the consumer information may also include information regarding particular coupons or incentives offered by the retailer to one or more of the selected consumers in the database, and the status of such offered coupons. Such status information regarding the coupons offered to the consumers may include, for example, information identifying particular coupons offered to selected consumers, whether the offered coupons have been viewed by the selected consumers, whether the offered coupons have been activated by the selected consumers, whether the offered coupons have been redeemed by the selected consumers, whether any offered coupons have expired, and any other such information useful to track and manage a selected consumer's response to one or more coupons offered to the consumer.

In addition to the coupon information and the consumer information, the database 116 may also include product information. The product information may include, for example, information identifying products offered for sale by the retailer. Such product identifying information may include, for example, product SKU number, title, description, image, brand, price, quantity, color, or any other product information commonly maintained by the retailer. It will be appreciated that the database information may be stored in a single database or multiple databases that are communicatively coupled to the coupon server device and the web server device via a local or wide area network such as the network 110. In addition, it will be understood that the data may be stored in any format, such as, for example, flat file format, relational format, normalized format. The data may also be stored in other formats such as XML, spreadsheet, or ASCII formats.

In one aspect, the coupon information and the consumer information contained in the database 116 may be used to determine and offer one or more coupons or incentives using the electronic address information of one or more of the consumers 114. For example, the coupon server 102 may lookup coupon information in the database 116 to create an email containing an offer for one or more coupons to be transmitted to one or more consumers identified by the consumer information in the database. Upon creation of the email including the coupon, the coupon server 102 may obtain the email address of one or more selected consumers from the consumer information stored in the database 112, and transmit the email coupon to the email addresses of the selected consumers over the network 110. In another aspect, the transmission of the email and the coupon to the selected consumers in the manner described above may also be implemented via another server such as a dedicated email server (not shown), that may be provided by a third party that maintains and provides marketing information to the retailer regarding potential consumers and facilitates communication between the retailer and such consumers. In addition to transmitting the email coupon to the selected consumer, the coupon server 102 may also update consumer information in the database to associate the transmission of a particular coupon with the selected consumer. As described below, the email coupon (or coupons) may then be received and viewed by the selected consumer using an email application running on the consumer devices 106, 108.

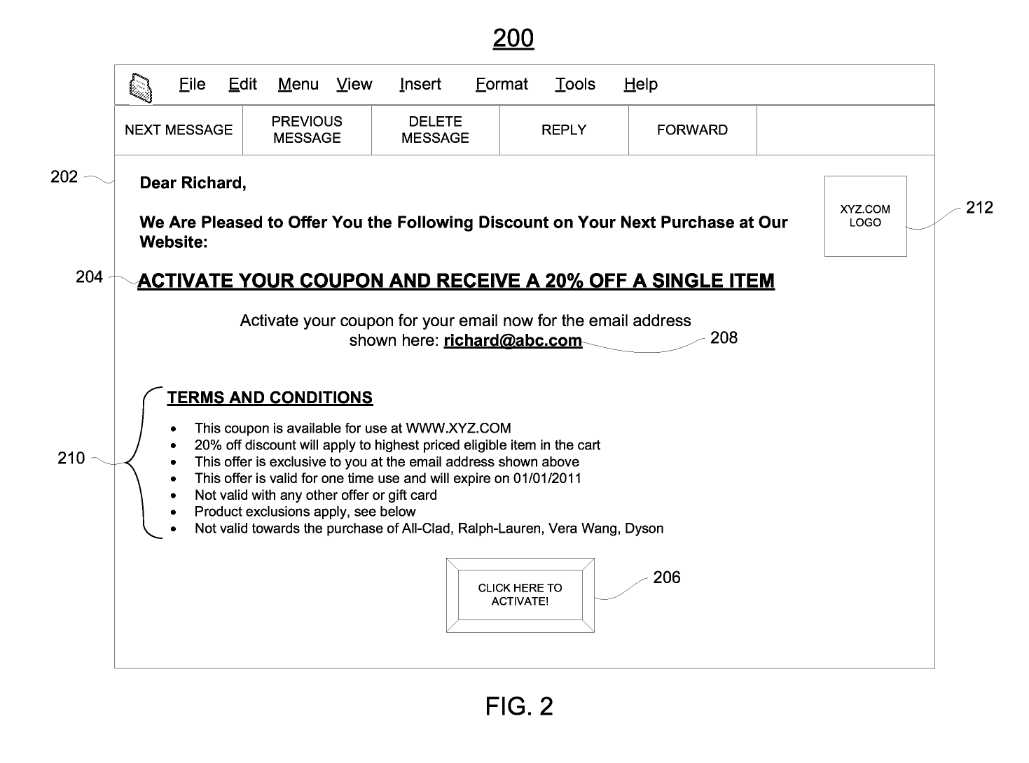

FIG. 2 illustrates a screen shot 200 of an exemplary email coupon 202 that may be transmitted to a selected consumer. The email coupon illustrated in FIG. 2 may be retrieved and viewed by the selected consumer in a conventional manner using a preferred email application, such as Microsoft's Hotmail application, Google's Gmail application, or any other suitable email application executing on the consumer devices 106, 108. The email coupon 202, which may be implemented using HTML, XML, SGML, Javascript, or any other suitable web scripting or markup language supported by conventional email and/or web browser programs, may prominently display textual and/or graphical information associated with the coupon to inform the consumer about the incentive being offered, identify the retailer offering the inventive, and enable further action by the consumer to activate and redeem the coupon.

As shown in FIG. 2, for example, the email coupon may include a prominent personal greeting to catch the consumer's attention as illustrated near the top portion of email coupon 202. As indicated by reference numeral 204, the email coupon may inform the consumer about the incentive offered by the retailer (here, “20% off one single item!”) and may invite the consumer to accept and activate the coupon by clicking on a link (here, activation link 206), provided in a convenient location in the email coupon. In addition, the email coupon may also display the email address 204 associated with the coupon.

In addition to the foregoing, additional information pertinent to the offered coupon may also be displayed in the email coupon. Such additional information may include, for example, the retailer's customer service contact information (shown at the near the bottom of email coupon 202), and may also include the terms and conditions 210 governing the use of the coupon. The terms and conditions 210 may prominently inform the user as to whether the offer is exclusive to the consumer or may be transferred, the date the offer expires (if any), whether the coupon may be combined with other incentives (e.g., gift cards or other discounts), and whether the offered incentive applies to, or excludes, any particular products, any particular types or categories of products, or any particular brands of products carried by the retailer. In addition to the foregoing, in a case where the coupon can be redeemed more than once, the terms and conditions 210 can also inform the user the number of times the coupon can be redeemed, and whether the coupon can be applied to multiple purchases in the same or different purchase transactions.

In one aspect, the email coupon 202 may also include information that, upon processing by the consumer's email application, provides information back to the retailer that the consumer has opened the email coupon. For example, the email coupon may include a script (not shown) that may be processed by the consumer's email application when the consumer opens the email. Such script may be implemented in HTML, Javascript, XML, or any other suitable scripting or markup language. Upon execution, the script may contain instructions which direct the email application to request a logo 212 from the coupon server 102 for display to the consumer in the email coupon 202. The logo 212 may be any image or text (e.g., the retailer's brand image or text) to be displayed in the email coupon. Receipt of such request by the coupon server for the logo 212 may be used as an indication that a consumer is viewing an email. In addition to a request for the logo, in one aspect the execution of the script may also transmit information to the coupon server identifying the particular email coupon being viewed by the consumer and the consumer's email address back to the coupon server. The coupon server may use this information to track and update the consumer information in the database 112 appropriately. For example, in one aspect, the coupon server may update the status of the consumer information in the database to reflect that a particular coupon offered to the consumer has been viewed. In this manner, the coupon server may not only provide a retailer's logo 212 that may be displayed to the consumer by the email application, but may also receive indication that a particular email coupon transmitted to a particular email address has been viewed by the selected consumer. Thus, the retailer may collect and analyze information regarding which of its consumers are considering, or at least viewing, it's offers.

Such collection and analysis may be advantageous in determining the effectiveness of the coupon program, including determining how many users that are viewing the emailed coupons, how many users are activating the coupons, and how many users are making purchases and redeeming the coupons, etc. In general, the collected information may be analyzed to understand and determine consumer trends, advertising effectiveness, etc.

If, upon viewing the email coupon, the consumer is interested in the incentive offered, the consumer may choose to activate the coupon by clicking on activation link 206. Clicking upon the link may then open a consumer's preferred web-browser program on the consumer's device, such as Microsoft's Internet Explorer browser or Mozilla's Firefox browser, and transmit a request (e.g., an HTTP or HTTPS request) to the web server 104 to activate the email coupon received by the consumer. As before, the request to activate the coupon may include information identifying the consumer (e.g., email address of the recipient) and may also include a coupon id identifying the particular coupon to be activated, thus enabling the web server 104 to activate the coupon by updating information in the database 116 appropriately. For example, the web server may update the status of the consumer information in the database to reflect that a particular coupon (or coupons) offered to the consumer has not only been viewed, but has also been activated. In one aspect, such update of the status of the consumer information in the database may be the only step in the activation of the coupon. In this manner, and as described above, the retailer may not only collect information regarding which of its selected consumers are viewing offered coupons, but may also receive information regarding the consumers that are expressing an interest in the retailer's incentives by activating the coupons.

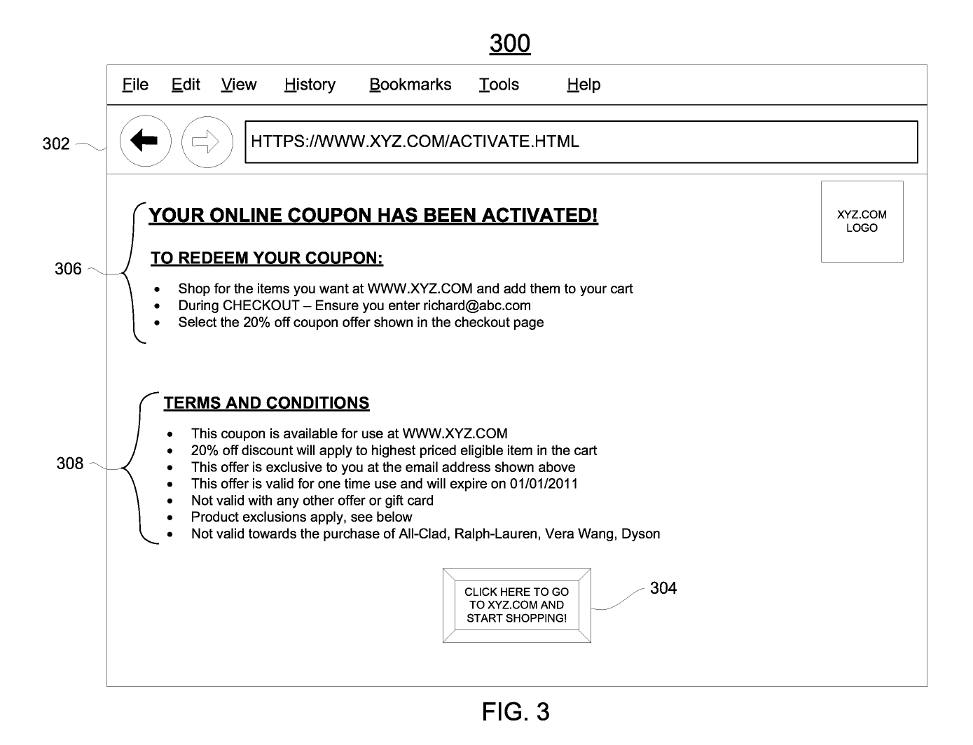

FIG. 3 illustrates an exemplary screen shot 300 of a web page 302 that may be transmitted to the consumer 114 by the web server 104 to notify the selected consumer that the email coupon 202 has been successfully activated. While a web page is depicted in FIG. 3, it will be noted that such notifications may also be transmitted in an email to the email address of the consumer. As with the email coupon, the web page may be implemented using HTML, XML, SGML, Javascript, or any other suitable web scripting or markup language supported by conventional email and/or web browser programs. As seen therein, the web page 302 may be displayed in the consumer's preferred web browser to prominently notify the consumer 114 that the email coupon 202 has been activated and is now ready for use, and invite the consumer to start shopping by clicking on a shopping link 304 provided in a convenient location of the web page. The consumer may then click upon the shopping link 304, to select and purchase items offered by the retailer. In addition, the web page 302 may also include instructions 306 on how to redeem the coupon, which, in one aspect, may inform the consumer that the selected consumer's email address should be entered during the purchase, and may also include the terms and conditions 308 to remind the consumer of any restrictions or conditions governing the redemption of the coupon as described before, such as the number of times the coupon can be redeemed. In addition to the foregoing, the web page 302 may also include other textual or graphical information that the consumer may be interested in, such as information regarding particular products being promoted by the retailer, or information regarding any current or upcoming sales or financing deals offered by the retailer.

The systems and methods disclosed herein may not only include updating the consumer information in the database to track whether particular coupons have been viewed, activated and redeemed by the intended consumers as disclosed herein, but may also include tracking and managing the consumer information to prevent potential fraud or misuse in several ways. For example, once a particular coupon offered to a selected consumer has been activated, additional attempts to activate the same coupon may be restricted. One such case may occur when the selected consumer attempts to activate an already activated coupon. This may occur, for example, if the consumer accidentally clicks the activation link presented in the email coupon 202 after the coupon has already been activated, or if the consumer forgets that the coupon has been activated and attempts to activate the coupon again. Another case may occur where a consumer tries to reactivate a coupon that can be redeemed multiple times. In such cases, the web server may check the status of the consumer information in the database (e.g., based on the consumer's email or other electronic address), and if the coupon associated with the selected consumer has already been activated, may simply inform the consumer that the coupon is already active and ready for use.

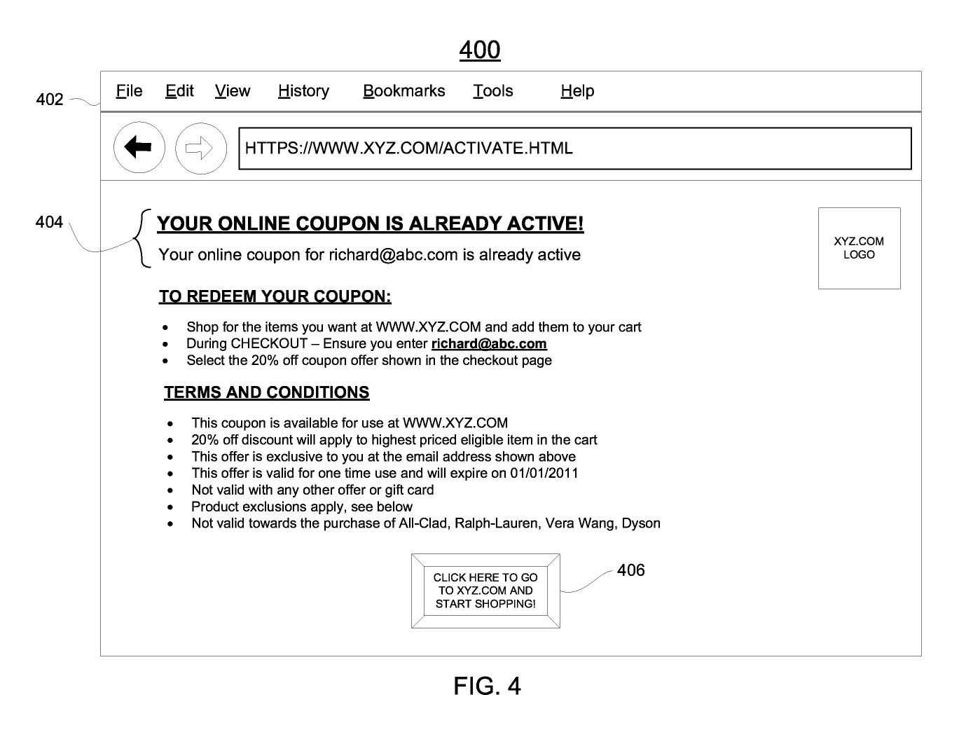

This is illustrated in FIG. 4, which shows an exemplary screen shot 400 of a web page 402 that may be transmitted to the consumer 114 by the web server 104 in response to a request for activation of a coupon that is determined to have been activated previously. As seen therein, the web page 402 may prominently notify the consumer that the coupon is already active (as indicated by reference numeral 404), and may additionally invite the consumer to begin shopping at the retailer's website by clicking on the shopping link 406. As before, the web page 402 may include other information, such as instructions for using the coupon and the terms and conditions governing the use of the coupon, or any information helpful to the consumer.

Another case in which one or more consumers may be prevented from activating the coupon may occur when a selected consumer that receives an offer forwards or distributes the email coupon to other consumers. In this case, attempts by such other unauthorized consumers to activate the coupon may be prevented. In one aspect, when the web server receives a request to activate the coupon from such other consumers, the web server may determine, based on the email address of the requesting consumer and the consumer information contained in the database, whether the email address of the requesting consumer matches the email address of one of the selected consumers to whom an offer for a particular (or any) coupon has been transmitted. If the web server determines that the requesting consumer is not one of the selected consumers that received an offer for a particular (or any) coupon, the web server may prevent the requesting consumer from activating the coupon.

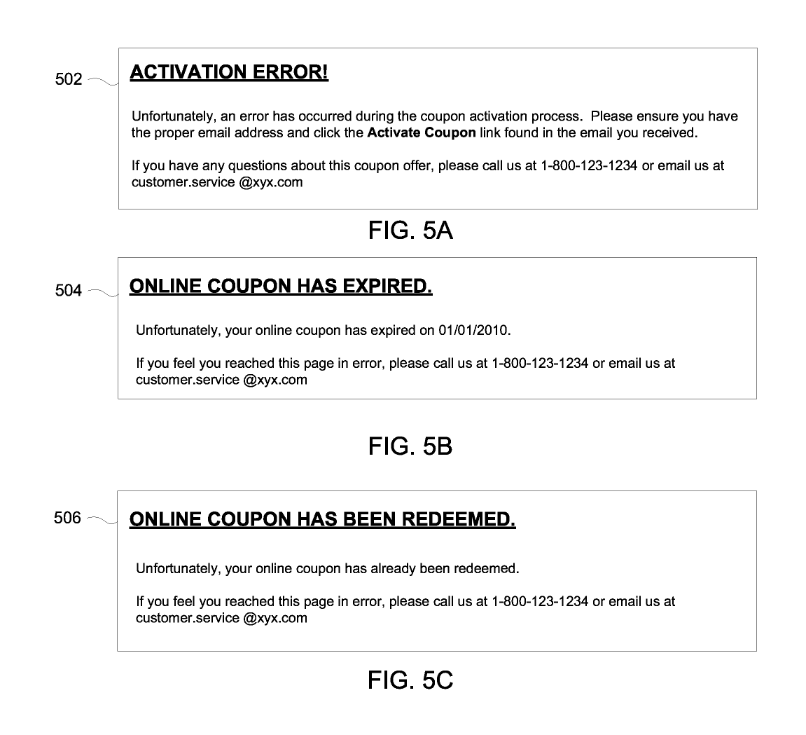

This is illustrated in FIG. 5A, which shows an exemplary screen shot of a web page 502 that may be transmitted when a consumer that is not one of the selected consumers in the database requests activation of an email coupon. As seen therein, the web page may prominently notify the consumer that there was an error in activating the coupon. In addition, the web page 502 may also inform the requesting consumer that the requesting consumer's email address did not match a valid email address associated with the offered coupon, and may invite the requesting consumer to register with the retailer to receive further offers or incentives from the retailer. Once the requesting consumer registers with the retailer (e.g., at the retailer's website or by calling customer service), the requesting consumer's information may be added to the consumer information in the database to enable the requesting consumer to receive current or future online coupons from the retailer.

In addition to the foregoing, attempts to activate or redeem email coupons that have expired and/or already been redeemed may also be prevented. In one aspect, when a request to activate or redeem a coupon is received, the web server may determine, based on the status of the consumer information contained in the database, whether the email coupon has expired. If it is determined that the coupon has expired, then the consumer may be appropriately informed that the coupon is no longer valid. This is illustrated in FIG. 5B, which shows an exemplary screenshot of a web page 504 that may be displayed, to inform the consumer that a particular coupon is expired. Alternatively, if the coupon has not expired, and the request is to activate an unredeemed email coupon, the web server may activate the coupon in the manner described above.

In the case where the web server receives a request to redeem a coupon, the web server may determine, based on the status of the information contained in the database, that while the coupon has been activated and has not expired, the coupon has already been redeemed. In this case, the web server may notify the requesting consumer appropriately as shown in FIG. 5C, which illustrates an exemplary screen shot of a web page 506 that may be displayed to notify the requesting consumer that the coupon has already been redeemed. Where a particular coupon is redeemable more than once, the web server may maintain status information in the database regarding the maximum number of times the same coupon can be redeemed, along with information regarding the number of times the coupon has actually been redeemed. The web server may thus provide appropriate notification (not shown) to the consumer based on a comparison of the maximum number of redemptions possible and the actual number of redemptions to determine whether the coupon can be redeemed again or not. For example, the web server may notify a consumer that a particular coupon is redeemable a maximum of 5 times, has already been redeemed 3 times, and can be redeemed twice more by the consumer in one or more additional purchase transactions. However, if the coupon has already been redeemed the maximum number of allowable times, the web server can notify the requesting consumer that the coupon has already been redeemed the maximum multiple number of times and cannot be redeemed any more times.

In view of the foregoing, it will be appreciated that various aspects of the systems and methods disclosed herein may not only enable a retailer to offer online incentives to selected consumers, but also enable the retailer to track and manage its offers to reduce possible fraud or misuse of such incentives.

The redemption of a previously activated and valid (i.e., unexpired) coupon is described below. As noted earlier with respect to FIG. 3, the selected consumer may begin redemption of an activated coupon by clicking on a link 304 on the activation notification page 302. In one aspect, clicking upon the link 304 may transmit a request (along with information identifying the consumer's email address and the activated coupon) to the web server. In response to such request, the web server may serve the retailer's homepage (not shown) hosted at the retailer website, which may then be viewed by the selected consumer in the consumer's preferred web browser. The consumer may then navigate one or more web pages at the retailer's website to search and browse for items offered for sale by the retailer. The selected consumer may also add one or more selected items to an electronic shopping cart provided on the retailer's website for eventual purchase. After selecting and adding items for purchase, the consumer may also elect to checkout and complete the purchase transaction, at which time the consumer may be presented with an opportunity to select and apply one or more activated coupons associated with the selected consumer towards the purchase of the items as described below.

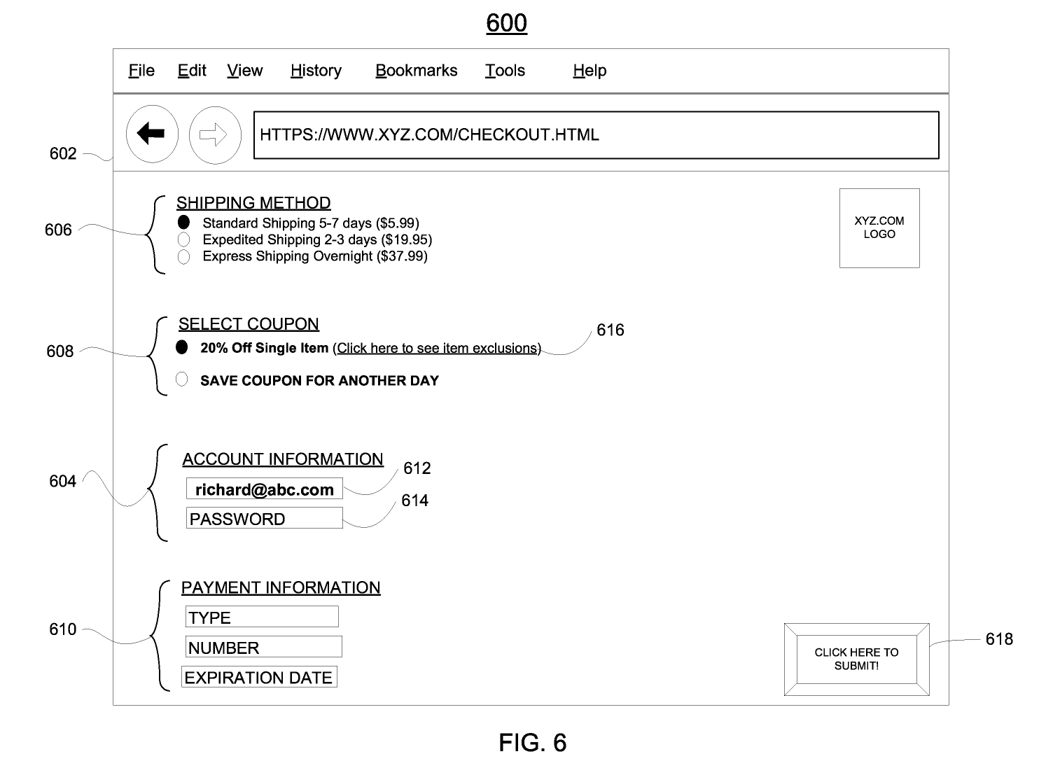

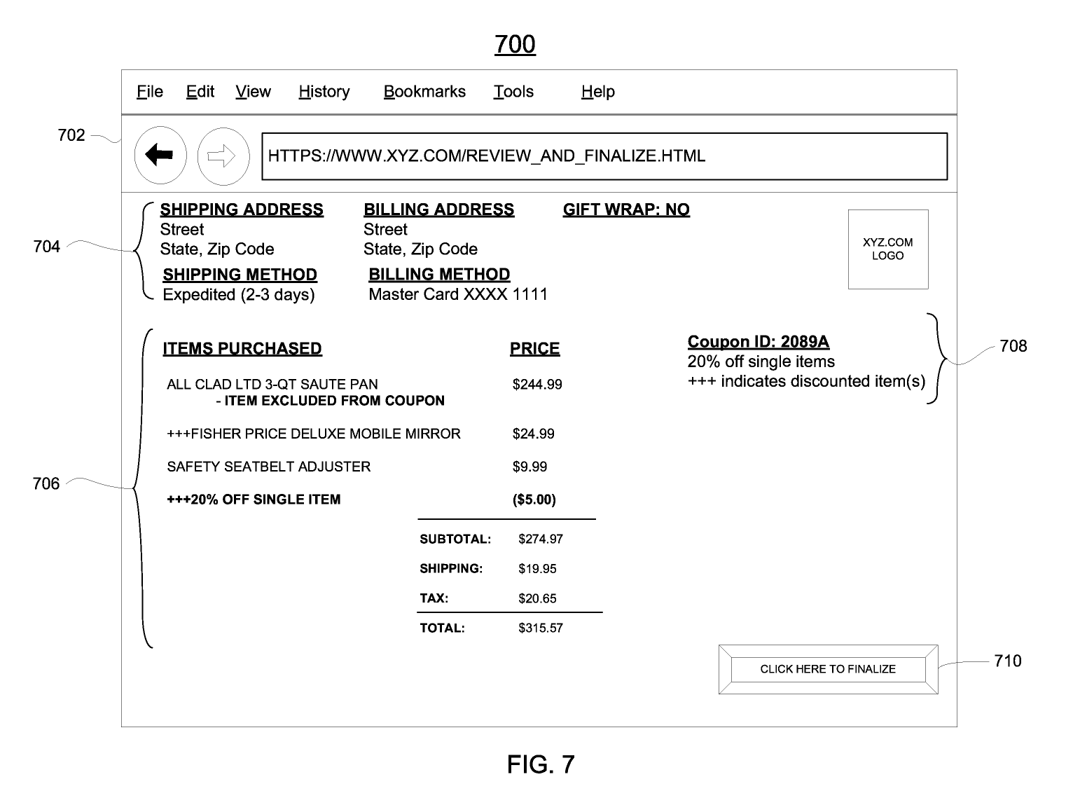

Referring now to FIGS. 6-7, FIG. 6 illustrates an exemplary screen shot 600 of a web page 602 that may be displayed to the consumer during the checkout process. As seen therein, the web page 602 may include information such as the consumer's login information 604, shipping method information 606, coupon information 608, and payment information 610. While the foregoing is illustrated in a single web page 602 for convenience, it will be appreciated that all or a portion of the information in web page 602 may also be provided to or obtained from the selected consumer in any number of linked web pages before, after, or during the selection of the items by the consumer.

As seen in FIG. 6, the login information 604 may include the selected consumer's email address 612 and password 614. In one aspect, the selected consumer may be prompted to enter both the consumer's email address 612 and password 614 for authentication purposes. In another aspect, the email address 612 may be automatically filled in by the web server based on the selected consumer's email address information obtained from the request that was generated when the selected consumer clicked on the shopping link 304 on the activated coupon page 302, or based on the consumer information stored in the database. In this case the consumer may only have to create and enter the password 614 for security during future transactions with the retailer.

The shipping method information 606 may allow the consumer to select a preferred shipping method for the selected items by comparing the cost of various shipping options (e.g., standard, expedited, express) based on the shipping address (not shown) provided by the consumer.

The coupon information 608 may identify one or more activated and valid coupon offers based on the consumer's email address and the consumer and coupon information stored in the database (here, the previously activated coupon offer for a “20% off highest eligible item”). In addition, the coupon information 606 may also include a link 616, which may be clicked by the selected consumer to view the terms or conditions, if any, associated with the activated coupon.

In one aspect, and as illustrated in FIG. 6, the coupon information 604 may also display activated coupons associated with the selected consumer, but may also provide the consumer with an option, but not the requirement, to apply any available activated coupon towards the purchase of the selected items. In the case illustrated in FIG. 6, for example, the selected consumer may choose to apply the 20% off coupon or may choose to save it for another purchase at another time. In this manner, the selected consumer may be provided with the option of choosing whether to apply the activated valid coupon to the instant purchase, or to save the activated coupon for future purchase.

The payment information 610 may prompt the consumer to identify and enter a preferred method of payment for the purchase of the selected items. For example, the selected consumer may be provided with an option of choosing a preferred payment method, such as any consumer preferred credit or debit card, gift card, the retailer's own credit or debit card, Paypal, or any other payment method accepted by the retailer. Thus, the consumer may not only be provided with flexibility to use or save the activated coupon, but may also be provided with the additional flexibility of redeeming the coupon towards any preferred method of payment chosen by the selected consumer during the purchase of the selected item. Given the way in which the online retailing operations have evolved, and the restrictions that have ensued, such flexibility can be important market factors in consumer satisfaction and convenience. Such flexibility may also encourage brand loyalty.

In addition to the foregoing, the web page 602 may also prompt the selected consumer for other information (not shown), such as, for example, the consumer's preferred shipping and billing address information, gift wrap information, and additional promotional incentives received by the selected consumer from the retailer via other sources, such as television or radio advertising, newspaper advertising, or postal advertising.

Finally, the web page 602 may also include a submit link 618, which may be clicked upon by the selected consumer after entering the requested information on the web page 602. Clicking the submit link may then transmit the information in the web page 602 to the web server, which may then update appropriate fields in the consumer information contained in the retailer's data base. In this manner, the web server may collect and store the information provided by the selected consumer, which may be used not only for generating reports and providing the selected consumer with additional incentives, but also to streamline future purchases by the selected consumer.

FIG. 7 is an exemplary screen shot 700 of a confirmation web page 702 that may be provided in response to the submission of information on web page 602 to the web server. As seen therein, the confirmation web page 702 may include details regarding the selected consumer's purchase transaction. Such information may include, for example, the shipping address information, the billing address information, gift information, shipping method information, and billing method information (collectively referred to as 704). Further, it may include the purchased item and cost information 706, and the applied coupon information 708. Finally, the confirmation web page 702 may also include a link 710, which may be clicked upon by the selected consumer to finalize the transaction.

The applied coupon information 708 may identify one or more incentives or coupons applied towards the purchase, here, the “20% Off Single Item” incentive. In addition, the purchased item and cost information 706 may include a list of all items selected for purchase by the consumer. As shown, in one aspect the purchase item information 706 may clearly identify any item excluded by the coupon (here, the “All Clad LTD 3-Quart Saute Pan”). As further shown, the application of the coupon towards the purchase price of one or more eligible items may also be indicated. In the case shown in FIG. 7, the highest priced eligible item is the Fisher-Price Deluxe Mobile Mirror priced at $24.99. Thus, applying the 20% discount to the price of this item results in a $5 savings towards the total cost of the purchased items. Upon receiving an indication upon the user clicking of the link 710, the web server may finalize the transaction. In addition, the web server may also update the status of the consumer information in the database 116 to indicate that the applied coupon has been redeemed. In the case where the applied coupon is redeemable more than once, the web server may also indicate the remaining number of times (if any) that the coupon may be redeemed, as a reminder and an incentive to the consumer for using the coupon again in additional transactions.

While the particular incentive offered to the selected consumers in the example above has been a percentage off discount, it will be appreciated that the systems and methods disclosed herein may be applied to various different types of incentives. For example, in one aspect the incentive offered may be a percentage off a total purchase price of all eligible items, rather than any one particular item. Further, the incentive offered may also be a dollar amount incentive, such as, for example, a $5 discount off the price of a particular item, or $5 discount off a minimum purchase of 15 dollars. In some aspects, the incentive may not be either a percentage or a price discount, and may instead be a quantity based discount (e.g., buy two get one free, or buy one get another half off). Further still, the incentive does not have to be tied to particular items, type of items, or items at all. In yet other embodiments, the incentive may not be a discount per se. For example, the incentive may include an offer for a free shipping and/or installation, an offer for financing, a trial offer, or any other type of value-added incentive designed invite a consumer to purchase or try various goods or services provided by the retailer.

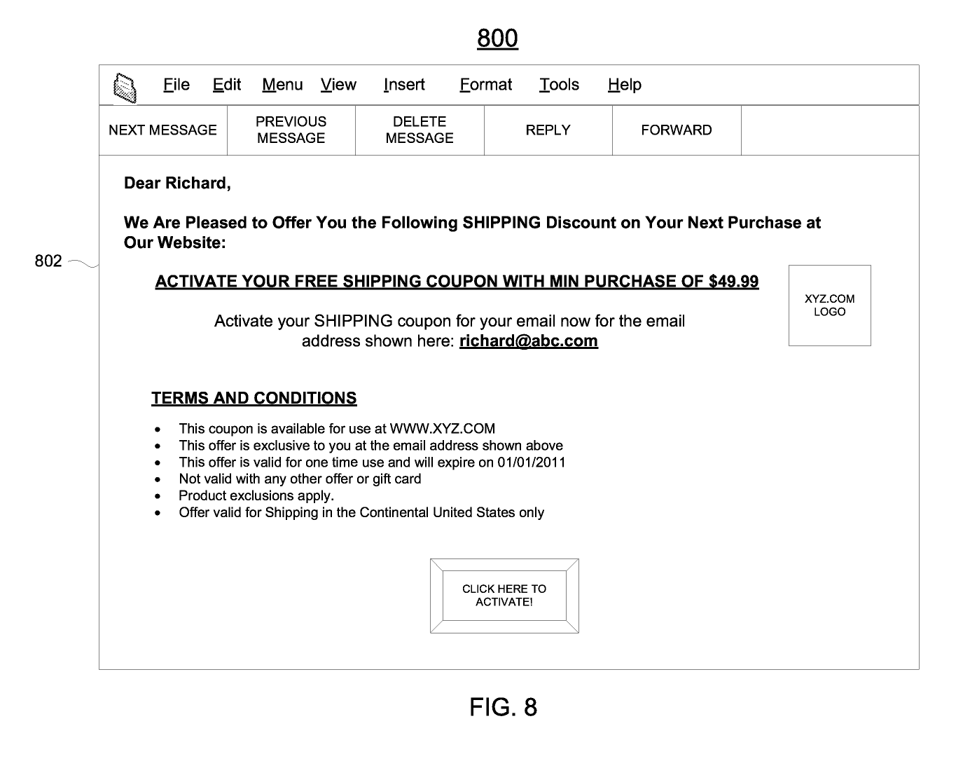

In one aspect the incentive may be service discount, such as a discount on the shipping fee, as exemplarily illustrated by screen shot 800 of a shipping incentive 802 in FIG. 8. Another type of service discount may include, for example, free installation or assembly of particular products purchased from the retailer.

In addition, while the above embodiments describe an online coupon that is transmitted as an email coupon to the consumer, the invention is not so restricted. For example, in another aspect the online coupon may be transmitted via Short Message Service (“SMS”) to an electronic SMS address of a selected consumer. In this case, the retailer may succinctly describe the incentive e.g., “20% off any single item from www.xyz.com!!”, and may provide a link to activate the offer as described above. In addition or alternatively, the online coupon could also be transmitted to a social network address of one or more selected consumers subscribing to a social network service, such as, for example, Facebook, MySpace, or Twitter.

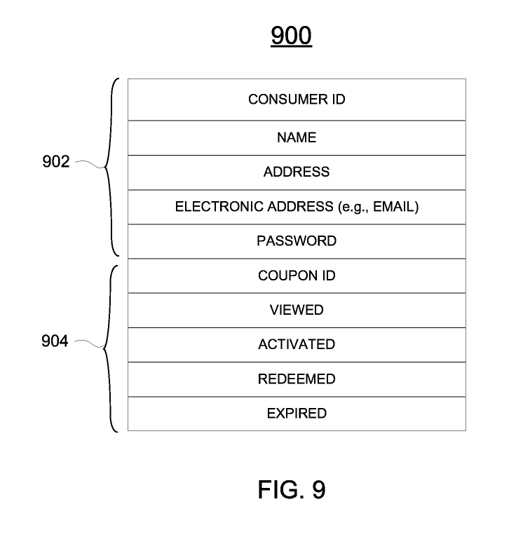

FIG. 9 shows exemplary consumer information 900 that may be maintained in the database 116 for one or more selected consumers in accordance with various aspects of the invention. As seen therein, the consumer information may include consumer identification and contact information 902 of each selected consumer, such as a consumers name, consumer id, email address, password, postal address, etc.

The consumer information 900 may also include coupon information 904 for each coupon offered to the selected consumer, such as for example, the coupon id information identifying one or more coupons or incentives offered to one or more selected consumers, whether the selected consumers have viewed, activated, or redeemed the offered coupon, and whether any coupons have expired prior to redemption.

The consumer information may include additional fields (not shown) such as the dates when one or more incentives was offered to the selected consumers, the dates when particular incentives were viewed, activated and/or redeemed by the selected consumers, the items that were purchased by one or more selected consumers in response to the offered incentive, the number of times a particular coupon was redeemed, the number of maximum possible number of redemptions, and any other information that a retailer may find useful for efficiently tracking and managing the status of the incentives offered to its consumers.

As may be readily appreciated, the consumer information 900 may also be analyzed to determine and generate reports regarding particular consumers that are actively viewing, activating and/or redeeming the incentives offered by the retailer. For example, the coupon server may periodically analyze the status of the consumer information and determine that a particular set of selected consumers activates, views and/or redeems 90% (or any predetermined percentage or number) of the incentives offered by the retailer. Such loyal consumers may be identified in a generated report and rewarded by the retailer by offering them free gifts, additional or exclusive discounts, more favorable financing rates, or in any other such ways.

In addition to identifying preferred consumers that are actively viewing, activating and/or redeeming offered incentives, the consumer information may also be analyzed to determine and generate reports regarding the most popular incentives. For example, the web server may determine based on the consumer information that a particular incentive result in a higher percentage (or number) of views, activations, and/or redemptions than others. By way of example only, if a particular incentive is viewed, activated, or redeemed 80% of the time (or any predetermined percentage or number of times) by the selected consumers, the retailer may determine that the particular incentive is more popular with the selected consumers than another incentive that results in a lesser percentage (e.g., 5%) or number of times the other incentive is viewed, activated, or redeemed by the selected consumers. Such valuable information may be used by the retailer to increase the supply of popular incentives and products to which they are applied.

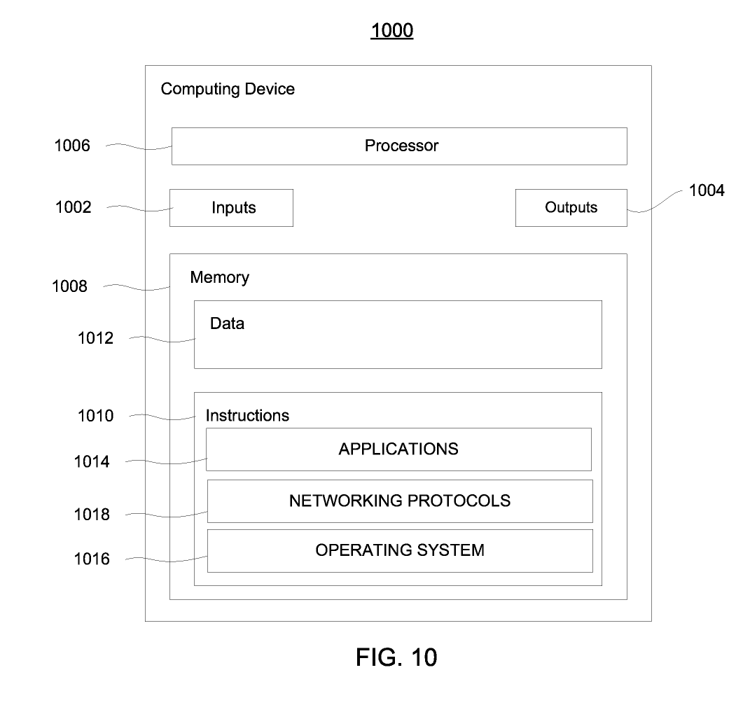

FIG. 10 shows an apparatus 1000 for implementing one or more of the components depicted in the system 100 presented in FIG. 1. As seen therein, apparatus 1000 illustrates one configuration of a computing device that may be used to implement the functionality of the coupon server 102, the web server 104, and the computing devices 106, 108 as described above.

The apparatus 1000 may include, for example, one or more user inputs 1002 such as a keyboard and mouse and/or other types of input devices such as pen-inputs, joysticks, buttons, touch screens, etc., as well as a display 1004, which could include, for instance, a CRT, LCD, plasma screen monitor, TV, projector, etc. As shown, apparatus 1000 further contains a processor 1006, and memory or computer readable medium 1008.

Memory 1008 stores information accessible by processor 1006, including instructions 1010 that may be executed by the processor 1008 and data 1012 that may be retrieved, manipulated or stored by the processor. The memory 1008 may be of any type capable of storing information accessible by the processor, such as a hard-drive, ROM, RAM, CD-ROM, DVD, Blu-Ray disk, flash memories, write-capable or read-only memories. The processor 1006 may comprise any number of well known processors, such as processors from Intel Corporation and Advanced Micro Devices. Alternatively, the processor 1006 may be a dedicated controller for executing operations, such as an ASIC.

The instructions 1010 may comprise any set of instructions to be executed directly (such as machine code) or indirectly (such as scripts) by the processor. In that regard, the terms “instructions,” “applications” and “programs” are used interchangeably herein. The instructions may be stored in any computer language or format, such as in executable/object code or modules of source code.

Data 1012 may be retrieved, stored or modified by processor 1006 in accordance with the instructions 1010. The data may be stored as a collection of data. For instance, although the invention is not limited by any particular data structure, the data may be stored in computer registers, in a relational database as a table having a plurality of different fields and records, XML documents, or flat files.

The data may also be formatted in any computer readable format such as, but not limited to, binary values, ASCII etc. Similarly, the data may include images stored in a variety of formats. Moreover, the data may include any information sufficient to identify the relevant information, such as descriptive text, proprietary codes, pointers, references to data stored in other memories (including other locations in a network) or information which is used by a function to calculate the relevant data.

Although the processor 1006 and memory 1008 are functionally illustrated in FIG. 9 as being within the same block, it will be understood that the processor and memory may actually comprise multiple processors and memories that may or may not be stored within the same physical housing or location. For example, some or all of the instructions and data may be stored on a computer-readable removable recording medium such as a CD-ROM, DVD or Blu-Ray disk. Alternatively, such information may be stored within a read-only computer chip. Some or all of the instructions and data may be stored in a location physically remote from, yet still accessible by, the processor. Similarly, the processor may actually comprise a collection of processors which may or may not operate in parallel. Data may be distributed and stored across multiple memories 1008 such as hard drives, data centers, server farms or the like.

In addition, the memory 1008 in apparatus 1000 may include one or more applications or programs 1014 adapted to provide the any of the functions described with respect to the coupon server 102, the web server 104, and the consumer devices 106, 108 in accordance with the various aspects of the invention discussed above. Each device may include and execute specific instructions or applications, desirably under management of the processor 1006 in conjunction with an operating system 1016 and networking protocols instructions 1018 to provide the functionality described above.

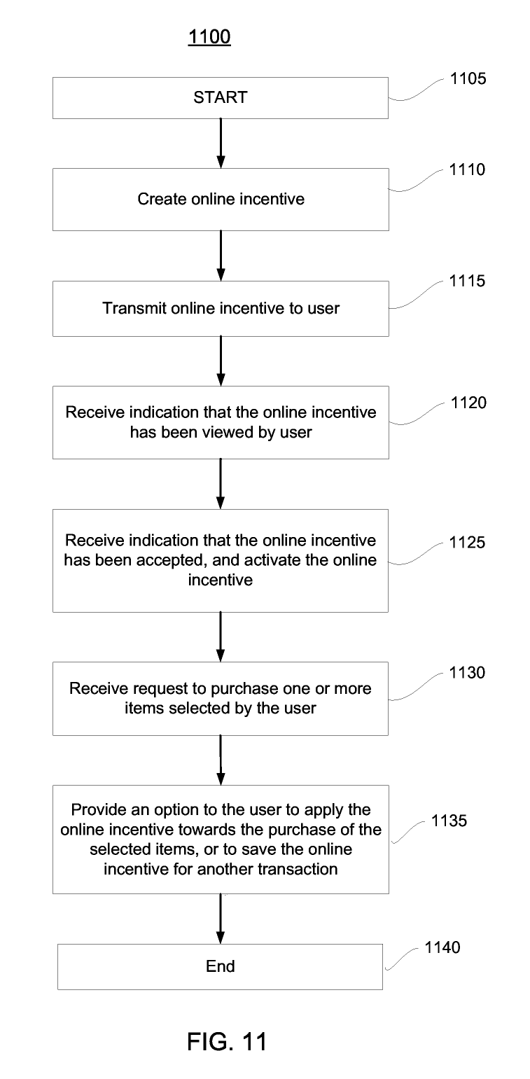

FIG. 11 is a flow chart of a process 1100 in accordance with various aspects of the systems and methods disclosed herein. The process begins in block 1105. In block 1110, an online incentive is created for transmission over an electronic network to a user. In one aspect, the online incentive may include an offer for a discount towards the purchase of one or more products carried by a retailer. In another aspect, the online incentive may offer a discount associated with one or more services offered by a retailer.

In block 1115, the online incentive is transmitted over the network to an electronic address associated with the selected user. In one aspect, for example, the electronic address may be an email address, and the online incentive may be emailed to the selected user. In other aspects, the electronic address may be a SMS address, a cell phone number a social network service address, or the like, and the online incentive may be transmitted as an appropriate message to the selected user.

In block 1120, the process may determine that the online incentive has been viewed by the selected user. For example, in one aspect the online incentive may include instructions, which, upon execution by the user's preferred application (e.g., email/web browser program), may transmit a request for additional information to a server provided by the retailer. In one aspect, the request may be a request for additional textual or graphical information to be displayed to the user viewing the online incentive, such as a logo identifying the retailer. In another aspect, the request may be for additional information regarding one or more products that the user may be interested in. In one aspect, the request may also include information identifying the user and the online incentive being viewed by the user. The reception of such request may be used as an indication that the user is viewing the online incentive. In addition, the information identifying the user may be compared with the electronic address to which the online incentive was transmitted, in order to confirm that the viewing user is the same as the selected user to whom the online incentive was transmitted.

In block 1125, the process may activate the online incentive based upon a determination that the selected user has accepted the online incentive. In one aspect, for example, the selected user may indicate acceptance of the online coupon by clicking on a convenient link displayed to the user. In another aspect, the user may indicate acceptance by replying to the sender of the message containing the online incentive. In one aspect, such determination may be based upon information identifying the user and the online incentive. As before, such action by the user may be used as an indication to activate the online incentive, and to notify the user (e.g., by transmitting an email message or by directing the user to one or more web pages) that the online incentive has been activated and is ready to be redeemed. Alternatively or in addition, the process may also notify if the online incentive has been previously activated, redeemed, or expired.

In block 1130, the process may receive a request to redeem the online incentive towards the purchase of one or more products or services offered by the retailer. For example, after the online incentive is activated, the user may select one or more items at the retailer's website and submit a request to purchase the selected items.

In block 1135, the process may provide the user with an option to apply the online incentive towards the user's purchase. For example, upon receiving the request to purchase one or more items selected by the user the process may provide the user with an option to apply the activated online incentive, subject to any terms or conditions, towards the purchase of one or more eligible items selected by the user. In one aspect, the process may also provide the user with the option to save the activated online incentive for a subsequent transaction and to purchase the selected items without redeeming the online incentive. Upon completion of the purchase transaction, the process ends in block 1140.

Although aspects of the invention herein have been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the invention.

1. A method for processing incentives via an electronic network, the method comprising:
receiving, over the electronic network, confirmation from a user indicating the user's acceptance of an incentive transmitted to the user over the electronic network, the incentive including a discount associated with one or more products or services offered by a retailer;
receiving, over the electronic network, a request from the user to purchase at least one of the one or more products or services associated with the discount; and,
providing, over the electronic network, the user with an option of 1) applying the incentive towards the purchase of the at least one product or service selected by the user or 2) saving the incentive for another purchase.

2. The method of claim 1, wherein the confirmation from the user indicating the user's acceptance of the incentive includes an electronic address of the user.

3. The method of claim 2, wherein receiving confirmation from the user indicating the user's acceptance further comprises activating the incentive in association with the user's electronic address based upon determining that the incentive has not expired, been previously accepted in association with the user's electronic address, and/or been previously redeemed in association with the user's electronic address.

4. The method of claim 1, further comprising providing the user with an option to purchase the selected items using a payment method selected by the user.

5. The method of claim 3, wherein activating the incentive further comprises providing a notification to the electronic address of the user that the incentive has been activated, and inviting the user to redeem the activated incentive over the electronic network.

6. The method of claim 1, wherein the discount is redeemable multiple times towards purchase of the one or more products or services offered by a retailer.

7. The method of claim 1, wherein:
receiving the request from the user to purchase the at least one of the one or more products or services associated with the discount further comprises determining that the discount has already been redeemed a number of times by the user, and the option of 1) applying the incentive towards the purchase of the at least one product or service selected by the user or 2) saving the incentive for another purchase is provided based on a determination that the number of times the discount has already been redeemed by the user is less than a maximum number of allowable times the discount can be redeemed by the user.

8. A method for activation and redemption of online coupons, the method comprising:
receiving an indication that an online coupon transmitted to the user over a network has been viewed by the user;
activating, with a processor, the online coupon in response to receiving an activation request over the network, the online coupon being activated in association with an electronic address of the user; and,
receiving, over the network, a request for purchase of one or more items selected by the user, and providing an option, but not a requirement, to the user to redeem the activated online coupon towards the purchase of one or more eligible items in the one or more items selected for purchase by the user.

9. The method of claim 8, wherein the electronic address of the selected user is an email address of the selected user, and wherein the online coupon is an email coupon transmitted to the email address of the selected user;

10. The method of claim 8, wherein providing the option to the user to redeem the activated online coupon towards the purchase of the one or more eligible items further comprises providing an option to the user to pay for the purchase of the one or more selected items using a payment method preferred by the user.

11. The method of claim 8, wherein the online coupon is associated with an expiration date, and wherein the online coupon is activated in response to receiving the activation request based upon a determination that the online coupon has not expired.

12. The method of claim 8, wherein the online coupon is activated in response to receiving the activation request based upon determining that the online coupon has not been previously activated.

13. The method of claim 8, wherein the online coupon is activated in response to receiving the activation request based upon determining that the online coupon has not been previously redeemed.

14. The method of claim 8, wherein activating the online coupon further comprises receiving an identifier electronic address in the activation request and determining that the identifier electronic address matches the electronic address of the user to whom the online coupon was transmitted.

15. The method of claim 8, wherein the one or more eligible items in the one or more items selected for purchase by the user are determined based on terms and conditions associated with the online coupon.

16. The method of claim 8, further comprising storing user information in a database, the user information including information identifying the electronic address of the user, the online coupon transmitted to the electronic address of the user, and status information, wherein the status information includes whether the user has viewed the online coupon, whether the user has activated the online coupon, and whether the user has redeemed the online coupon.

17. The method of claim 8, wherein:
receiving the request for the purchase of the one or more items selected by the user further comprises determining that the activated online coupon has already been redeemed a number of times by the user, and the option, but not the requirement, is provided to the user to redeem the activated online coupon based on a determination that the number of times the activated online coupon has already been redeemed by the user is less than a maximum number of allowable times the activated online coupon can be redeemed by the user.

18. A computer-readable medium encoded with instructions executable by a processor for processing coupons, the instructions, when executed by a processor, configuring the processor to:
receive confirmation from a user indicating the user's acceptance of an coupon transmitted to an electronic address of the user, the coupon including a discount associated with one or more items sold by a retailer;
activate the coupon in association with the electronic address of the user in response to receiving the confirmation, and notify the user at the electronic address that the coupon has been activated;
receive a request from the user to purchase a selected one of the one or more items sold by the retailer in association with the electronic address of the user; and,
provide the user with a first option to purchase the selected item using a payment method selected by the user and a second option to apply the coupon towards the purchase of the selected item.

19. The computer-readable medium of claim 18, wherein electronic address is an email address associated with the user and the coupon is an email coupon that is transmitted to the email address associated with the user.

20. The computer-readable medium of claim 19, wherein the transmitted email coupon is configured to provide a notification that the user has or is viewing the email coupon, and the instructions further configure the processor to receive the notification in association with the electronic address of the user over the network.

21. The computer-readable medium of claim 18, wherein the electronic address includes a Social Messaging Service (“SMS”) address associated with the user.

22. The computer-readable medium of claim 18, wherein the instructions further configure the processor to associate the coupon with an expiration date and activate the coupon based upon a determination that the coupon has not expired.
